(19) United States
(12) Patent Application Publication
(10) Pub. No.: US 2014/0298887 A1
(43) Pub. Date: Oct. 9, 2014

(54) WHEELED VEHICLE ROLLOVER PERFORMANCE TESTING SYSTEM

(71) Applicant: Carl E. Nash, Washington, DC (US)

(72) Inventor: Carl E. Nash, Washington, DC (US)

(21) Appl. No.: 13/859,266

(22) Filed: Apr. 9, 2013

(51) Int. Cl. G01M 17/007

(52) U.S. Cl. CPC G01M 17/0078
USPC 73/12.04

(57) ABSTRACT

This invention is for a simple, dynamic test device and its use to assess a wheeled vehicle's dynamic performance leading to a rollover including such conditions as a curb tripped rollover, a vehicle's occupant restraint performance before and during the first roll, the motion of the vehicle's occupants before and during a rollover, and the vehicle's occupant protection performance in a rollover including its roof crush resistance. It does so by carrying a vehicle over a horizontal circular path at a speed sufficient that the centrifugal force on the vehicle will cause it to roll. The device provides unique, repeatable test conditions leading to a rollover as well as during the rollover. The device can also be used to test an object by subjecting it a high level of acceleration, force, and yawing motion about orthogonal vectors.

### FIELD OF THE INVENTION

The present invention relates to a device and procedure for testing wheeled vehicles to observe and document a vehicle's dynamic performance and occupant motion prior to and during single or multiple rollovers, assessing the vehicle's occupant restraint system performance—including deployable restraint triggering—under rollover conditions, and determining the vehicle's occupant compartment integrity and occupant protection performance leading up to and during a rollover. The device of this invention can also be used as a rotating test sled that imparts high levels of longitudinal acceleration and lateral forces on a test object yawing about an orthogonal axis.

### BACKGROUND OF THE INVENTION

The safety of a wheeled motor vehicle is enhanced if it has a reduced tendency to roll over, if it is built to preserve the occupant compartment survival space under foreseeable crash conditions, and if it is able to restrain and protect passengers and cargo in the event of a collision or rollover. A vehicle's dynamic stability and resistance to rolling over, the performance of its occupant compartment (particularly its roof) in resisting deformation and collapse, the performance of passive and actively deploying occupant restraints, and other aspects of occupant protection before and during rollover and collision events can be reasonably modeled by computer. However, there remains the need for low cost, realistic, repeatable, dynamic physical testing of complete vehicles for all aspects of their pre-rollover and rollover performance.

The primary indication of a vehicle's tendency to roll over is its static stability index (SSI) which is the ratio of a vehicle's center of gravity height to half of its track width. More sophisticated, common ways of assessing roll stability include a tilt table test, a decreasing radius curve test, a J turn test, and a fishhook test.

The simplest and most limited indication of a vehicle's ability to protect occupants when it rolls over is the quasi-static roof crush resistance test that has been used by the Federal government for about 40 years (49 C.F.R. 571.21.6). In that test, a large platen is pressed against a front corner of a vehicle's roof at a defined angle to determine whether the roof can resist a defined force without crushing more than a defined distance. The test was adopted in the early 1970s for passenger cars, amended to include light trucks in the mid-1990s, and substantially upgraded in 2009. The Insurance Institute for Highway Safety uses a somewhat different version of this test for its vehicle safety rating program. Although a roof that does will in this quasi-static test improves the odds of surviving a rollover, the use of safety belts and the ability of a vehicle to contain its occupants during a rollover are also critical to survival without serious injury.

Dynamic rollover testing provides a more realistic indication of the rollover safety of a vehicle. Devices for subjecting vehicles to destructive dynamic rollover testing are well known. The government's dolly rollover test (49 C.F.R. 571.208) has been used for more than 40 years, but that test does not provide consistent results. The Jordan Rollover System (JRS—U.S. Pat. No. 7,173,801: 2006) is useful for conducting realistic, repeatable dynamic rollover testing in an inertial, but moving frame of reference. The JRS requires permanent attachment of “a cradle to support and rotate a test vehicle.” The Controlled Rollover Impact System (CRIS—U.S. Pat. No. 6,651,482: 2003) tests vehicles in a fixed inertial frame of reference, but requires “at least one selectively releasable attachment member . . . . ” This is a heavy structure that is permanently attached to the test vehicle. CRIS also requires a tractor-trailer and a long track over which the tractor-trailer can be driven at the speed necessary to launch a test vehicle. Prior to testing in the CRIS system, the vehicle with its attachment member must be dynamically balanced. Although JRS and CRIS have a high degree of repeatability, they fail to reproduce rollover conditions as realistically and inexpensively as possible. Neither can test the dynamic stability of a vehicle, the conditions leading to the first roll, or the conditions of a typical first roll.

The conditions for the first vehicle roll are generally different froth those of subsequent rolls. In the first roll, the vehicle often yaws as it begins to roll and the roll may not be about the vehicle's principal axis of rotation. In subsequent rolls, the vehicle more typically rolls laterally, roughly about its principal axis of rotation. Furthermore, any deployable occupant restraints will be deployed as the vehicle is beginning its first roll while they will have been fully deployed for any subsequent roll. Thus, a different set of conditions is appropriate for testing the first roll than for subsequent rolls.

A dynamic rollover test system has four components: (1) a vehicle thrust system to impart dynamic linear and roll motion to a vehicle that results in roof impacts at given horizontal and vertical velocities, roll velocity, roll angle, pitch, and yaw; (2) a roof impact surface (which may be the ground) to subject the occupant compartment and particularly the roof to realistic rollover collisions and from which information on the characteristics of roof impacts can be recorded, (3) space in which the vehicle can come to rest or a means of arresting or capturing the vehicle following the initial roof impact or impacts; and (4) instrumentation and video that can document and record the consequences of the rollover test.

Until now, no test mechanism has been able to fully, realistically and repeatably assess the basic, typical conditions leading to a rollover as well as the conditions of the first rollover itself, whether tripped or not. Such a mechanism must reasonably emulate the dynamic forces on the vehicle through this process so that an occupant surrogate within the vehicle and the occupant restraint system is realistically exposed to the forces within the vehicle as it is launched into a rollover and during the first roll of the vehicle.

A test sled, a device that can impart high accelerations on a test object in one direction, is a common test device for motor vehicles and components. There exists no test sled that can impart longitudinal and lateral acceleration on a yawing object

### BRIEF SUMMARY OF THE INVENTION

The present invention is for a device to be used to conduct dynamic pre-roll and rollover testing of wheeled motor vehicles. A vehicle to be tested is placed on a platform supported by wheels that ride on a smooth, circular track. The platform is constrained to circular motion in a horizontal plane by being attached to arms that are connected to a hub with a bearing riding on a strong vertical axis that is firmly imbedded in the earth. The platform is moved by an engine, motor or other means either driving through the wheels riding on the circular track, or through cables and pulleys attached to the platform or its arms.

The vehicle can be placed in various positions and orientations of roll, pitch, and yaw on the platform. The vehicle may be permitted to slide on the platform before beginning to roll during a test with various coefficients of friction between the platform and wheels. The platform may have curbs or other obstructions installed on it to halt the vehicle's slide and to induce a rollover.

Tests conducted on this device are to assess and measure vehicle dynamics and occupant motion prior to and during single or multiple rollovers, assess occupant restraint system performance including deployable restraint triggered by rollover conditions, and assess the vehicle's roof crush and occupant protection performance leading up to and during a rollover. A particular advantage of the device is that it can uniquely be used to emulate a curb tripped rollover by permitting the vehicle to slide outward on the platform before the outboard wheels come into contact with a curb installed on the platform. The device of this invention can also be used as a rotating test sled that imparts both high levels of longitudinal acceleration and lateral forces on a yawing test object where the vectors of the three are orthogonal.

The device of this invention is superior to current dynamic rollover test devices in that it requires neither that significant parts be removed from the test vehicle nor that any type of frame or carriage be attached to the vehicle. It also can realistically simulate the pre-roll and first roll conditions as applied to a vehicle and its occupants that are typical of actual rollovers.

### BRIEF DESCRIPTION OF THE DRAWINGS

The features, objectives and advantages of this invention will become more obvious and better understood when considered in conjunction with the accompanying drawings. In these drawings, similar reference characters designate the same or similar parts throughout the several views.

FIG. 1 is a plan view (overhead) of the device showing the central axis and hub 1, the arms 2 attached to the hub through a bearing that permits rotation in a horizontal plane, the vehicle platform 3 mounted on the arms 2, support wheels 4 under and/or ahead and behind the platform, a circular track or rails 5, and a top view of a test vehicle (shown in outline) ready to be tested. The central axis 1 is imbedded in the earth in a large anchor such as a concrete foundation 7.

FIG. 2 is a side view (looking along a radius of the circular path of the test vehicle) of the vehicle platform. The numbers refer to the same elements as in FIG. 1.

FIG. 3 is an end view of the platform looking along a tangent of the circular path that the platform takes around the axis with the test vehicle in its pre-test position. Again, the numbers refer to the same elements as in the earlier figures.

FIG. 4 is the same view as FIG. 3 except that it shows the vehicle in its post-test position for the case where it has been restrained from a complete rollover by tethers 8, around the vehicle 6 that have prevented a complete rollover. If the tethers were absent, the vehicle as shown would be just at the point where it is launched into a rollover.

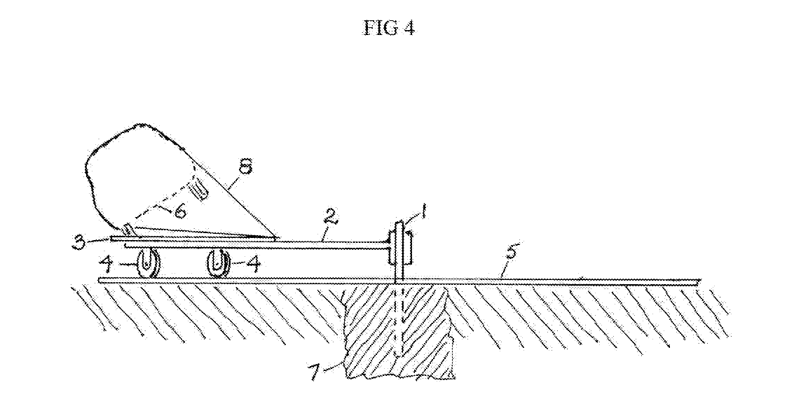

FIG. 5 is a perspective view of the system with its launch mechanism 1-7, impact platform 9 and restraining system (netting held at its ends by poles in this case) 10. The wheels supporting the platform are under the platform and not visible in this view. The test vehicle 6 is shown on the platform before it has been released. At this point, the platform and vehicle would be moving at a speed such that the centrifugal force on the vehicle is sufficient to precipitate a roll.

FIG. 6 shows the platform having advanced around its track, and the vehicle 6 having been released and beginning to roll on the platform 4.

FIG. 7 shows the vehicle 6 having rolled off the platform 4 and with its roof in contact with the impact platform 9 as it rolls over. In this view, the platform 4 has continued in its circular path. The vehicle would continue from what is shown in FIG. 7 into the restraining system 10 where it is brought to rest.

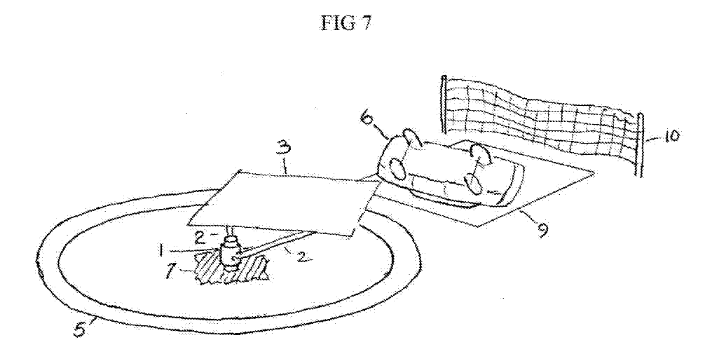

In these figures the source of power to rotate the platform is not shown. Such power would be provided by motors or engines that would drive the wheels 4, directly or through transmissions, shafts, belts or chains. Alternatively; pneumatic, hydraulic, or electric power could be applied to the platform through cables, pulleys or other means.

### DETAILED DESCRIPTION OF THE INVENTION

The present invention is for a device that simulates the conditions leading to a first roll and a complete rollover of a wheeled vehicle. It provides forward velocity, yaw, and lateral forces that are similar to those that often occur, leading to actual rollovers. The motion of a wheeled test vehicle (hereinafter as “vehicle” that is typically powered by an engine or a motor) undergoing a test on this device provides a dynamic environment for vehicle occupants and their restraint systems that often occur prior to and in actual rollovers so that occupant dynamics and restraint system performance can be observed, measured and documented in a test using this device.

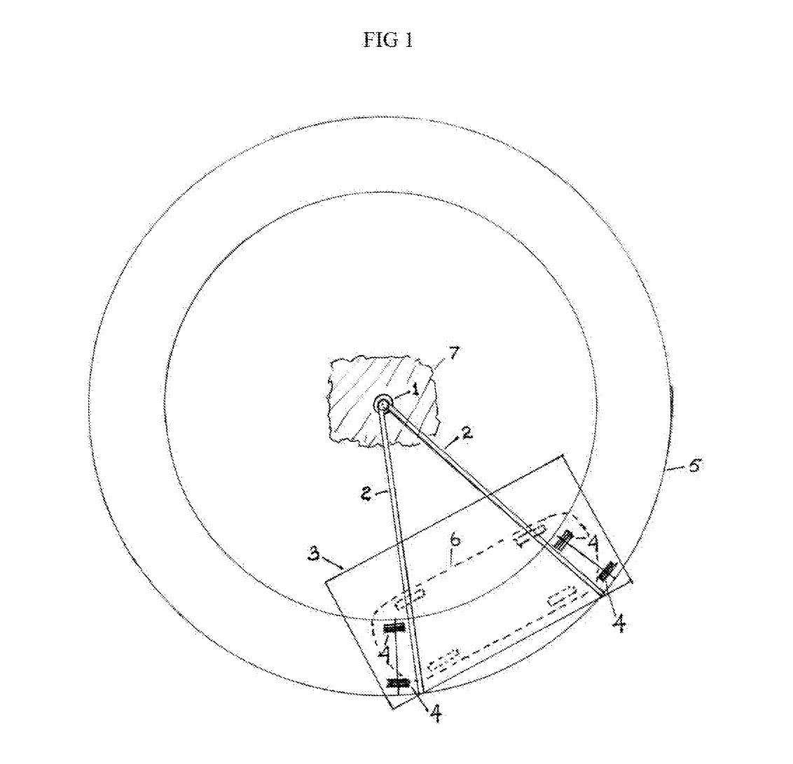

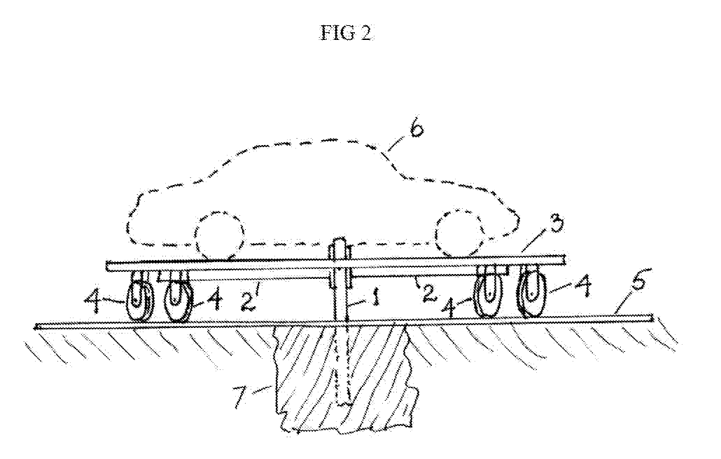

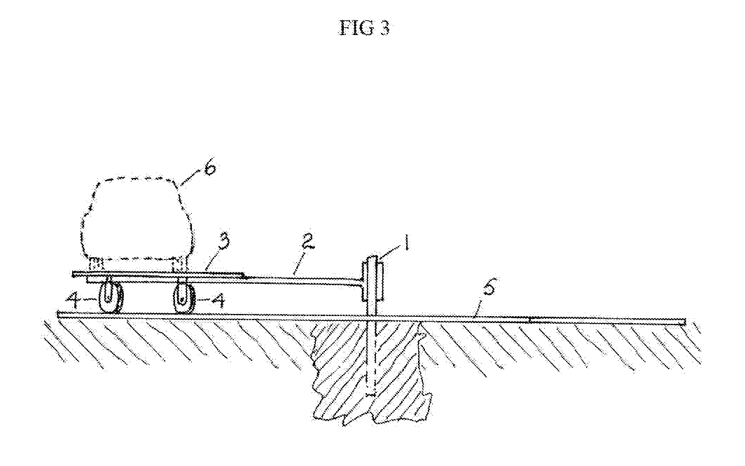

FIG. 1 shows the device which consists of a central axis 1 firmly embedded into the earth 7, a pair of arms 2 that are attached at one end to a bearing riding on the central axis such that the arms are free to rotate in a horizontal plane, and at the other to as platform 3 sufficiently large to carry a test vehicle under various test conditions. The platform is carried on wheels 4 riding on a hard, flat, smooth circular track 5 under the device. The wheels are located underneath and/or ahead of and behind, the platform. The wheels are either rubber tires rolling on this track or steel wheels rolling on a circular steel track or tracks. This is shown in FIGS. 2 and 3.

The device may be completely supported on the central axis although the strength of the central axis and arms would have to be substantially stronger and heavier, and the system might have to be at least partially counterbalanced. A more practical and secure means of supporting the platform is described in the previous paragraph.

The device is powered by engines, motors, pneumatic drives, hydraulic drives or other means driving through the wheels or directly through belts or cables and pulleys on the rotating mechanism mounted on the central axis to accelerate the platform. The power must be sufficient to accelerate the vehicle and platform to a speed where the vehicle will either roll or slide off the platform.

The central axis 1 and frame elements 2 of this invention are made of steel, aluminum, or other strong materials. The platform 3 is made of metal, wood (such as plywood) or other strong sheet material. The various components are welded or bolted together. The support wheels 4 are held by axles that are attached to either the platform or frame elements by brackets. Engines or motors are installed under or toward the axis from the platform so that they do not interfere with the vehicle being tested. They provide power to the wheels through shafts, belts or chains and, as necessary, through transmissions.

Vehicle restraints; including straps, curbs, and hinges; are attached to either the platform or arms of the device, and are temporarily attached to or in contact with the test vehicle. Such restraints can be triggered to release under predetermined conditions. Brackets to hold instrumentation and cameras that document tests are attached to the platform or other parts of the device.

The pre-roll motion includes yaw (from the rotation of the platform at the ends of the arms) and roll induced by the centrifugal force (also due to the rotation of the platform). There may also be longitudinal acceleration or deceleration of the vehicle mounted on the platform and the vehicle may be initially rolled, pitched or yawed on the platform.

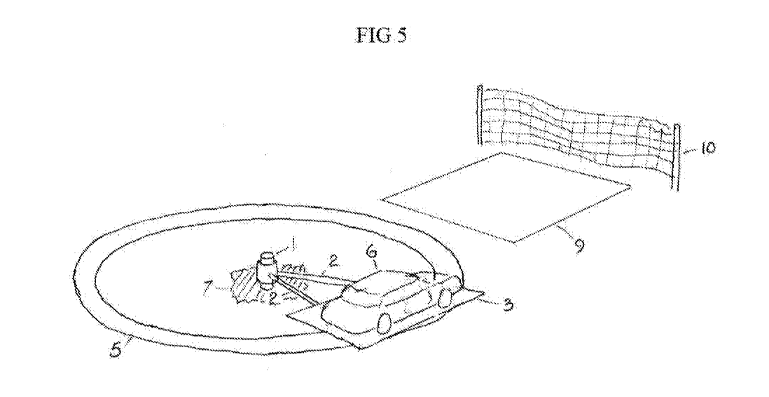

To initiate a test, a vehicle is placed on the platform 3. Its orientation is perpendicular to the axis of the system (i.e. with its longitudinal axis tangential to the arc of the platform's travel) or initially yawed to some degree (to represent oversteer or understeer), pitched or rolled (see FIGS. 1-3, 5). The vehicle can be initially held until a pre-determined speed is reached after which it is released to either slide radially (with varying degrees of friction) on the platform (such as into a curb or even off the platform to roll over on the ground surface) or it can be free to roll or slide off the platform when the centrifugal force becomes sufficient. The vehicle can be constrained until the speed is built up beyond the point at which the vehicle might initially roll to increase its roll velocity.

The device can be used to emulate a curb tripped rollover by initially installing it toward the inboard side of the platform. Then, once the speed of the platform has increased to the point where it would initiate a rollover, releasing the vehicle. This would permit the vehicle to slide outward on the platform until its outboard wheels come into contact with a curb installed on the platform which would precipitate a rollover.

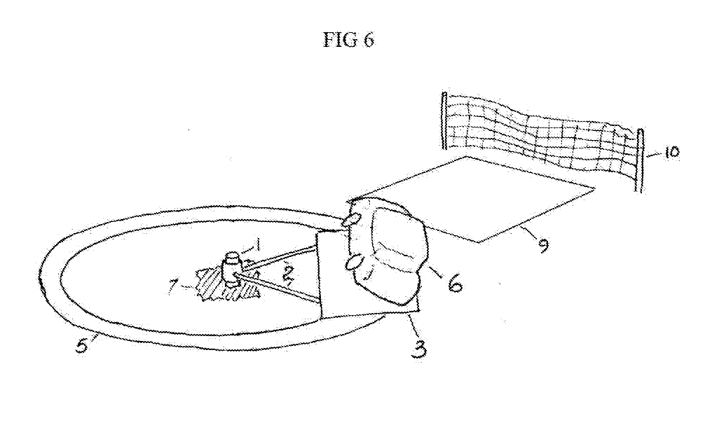

As the platform is rotates the centrifugal force (velocity²/radius) will induce a test vehicle rollover if its outboard wheels are constrained in some way as shown in FIG. 6. The vehicle can also be permitted to slide or roll off the platform onto the ground or onto an impact platform (for a destructive test of its roof and occupant protection performance). Alternatively, the body of the vehicle can be tethered 8 so that it is permitted to roll only until it reaches a launch point at a roll angle of approximately 45°, but is restrained so that it cannot to continue to roll or to leave the platform.

In another type of test, the vehicle is held in its initial position on the platform and when the platform reaches a pre-determined speed, the vehicle is released and slides radially off the platform. The outboard wheels begin to fall toward the ground first, when they have left the platform, inducing a roll motion of the vehicle. Then, when the outboard wheels strike the ground, they provide a further rolling moment that, if the vehicle's speed is sufficient, will result in a rollover of the vehicle on the ground.

Holding the vehicle until the platform reaches a defined position will aim the vehicle's trajectory along a particular path to enhance the repeatability and reproducibility, and to facilitate documentation of its rollover performance. Such a release will also aim the vehicle to rollover on an impact platform.

To conduct a non-destructive test of vehicle dynamics or of initial occupant restraint performance, a vehicle may be somewhat loosely tethered so that it can only roll to a moderate degree but not be permitted to complete its roll. Tethering may be, for example, by nylon or Dacron straps 8 or netting around the body that are attached to the arms and/or platform of the device.

A test with the vehicle so tethered can provide information on the its dynamic performance under conditions that would precipitate a rollover as well as information on the conditions appropriate to deploy active restraints such as window curtain air bags and safety belt pretensioners.

There are several ways in which the vehicle can be constrained to induce rollover from the platform depending on the purpose of the test:
Its outboard wheels can be constrained by a curb or by a plastic hinge attached to the outboard wheel hubs at one end, going under the wheels, which is then attached to the platform directly or through an energy absorbing system to simulate a vehicle sliding through a resistive medium such as soil or sand. Under these conditions, as the platform rotation speed is increased, the vehicle will become unstable and begin to roll.
One or both ends of a vehicle can be installed somewhat inboard on the platform and be permitted to slide, at a prescribed friction coefficient, outboard into either a curb or a plastic hinge to precipitate a rollover either with the vehicle tethered or free to roll over.
Some of the wheels of the vehicle may be elevated to simulate roll or pitch prior to the initiation of the rollover.

A vehicle can also be installed and initially restrained on the platform, and when the platform reaches a given speed, the restraints will be triggered to release the vehicle so that it slides off the platform. The outboard wheels, having fallen and precipitating the vehicle's roll, will then strike the ground and the vehicle will roll over.

If the vehicle is not tethered, it may be arrested before the end of one roll by an energy absorbing device such as netting without further damaging the vehicle. In this case, the vehicle can be retested to simulate a second roll. Alternatively, it can be permitted to roll until it comes to rest on its own.

This device does not require a cradle or other member permanently attached to a test vehicle, so that only minimal vehicle preparation is necessary. Installation of the vehicle into the fixtures is therefore relatively quickly and easily achieved. Furthermore, once the vehicle is released to undergo test rollovers, it is unencumbered by any significant attachments. Furthermore, no significant parts of the vehicle need to be removed prior to testing. The device can be used to conduct first and even subsequent rollover tests within a limited space that can be within a building and does so in a stationary, inertial frame of reference.

As with other dynamic rollover systems (see Background, above), this device has a vehicle thrust device which is the heart of this invention. The thrust device initiates a rollover test by emulating the conditions preceding a rollover and the first roll of a motor vehicle that includes roll and yaw motions along with forward, lateral and vertical velocity. The device can be used to emulate a second, the subsequent roll by adjusting the conditions under which the vehicle is launched.

The device of this invention initially imparts a highly controlled, accurate motion to a vehicle that includes translation, roll, pitch and yaw. When the desired conditions are achieved, the vehicle is released from the mechanism, as it rolls, it becomes completely unconstrained and ballistic for a short period after which it lands, typically on some part of its roof, on the ground or on an impact platform over which it rolls. The resulting roof impacts realistically simulate the roof impacts of typical vehicle rollovers. During the roof impacts, sensors and video systems can collect information on the vehicle's performance. Following the roof impacts, the vehicle is arrested in a manner that does not inflict significant further damage on it or is permitted to roll until it comes to rest. It may then be remounted for a second roll test of its performance in a second roll either on the present device or on one such as a Jordan Rollover System.

The device can also be used to test the dynamic behavior of a vehicle under conditions leading up to a rollover, and the performance of static and deployable occupant restraint systems, without significantly damaging the vehicle by tethering it so that it will not be released to complete its rollover.

The method of the invention is first to place the vehicle on the platform in the appropriate position and orientation, and to temporarily secure it as appropriate. Second, curbs, plastic hinges, or other means to precipitate the rollover are installed as appropriate for the particular test. Third, photographic and measuring equipment (including anthropometric test devices) are placed. Finally, the input power profile of the system and vehicle release conditions are established. The test is then commenced and the results recorded.

A significant aspect of the invention is that the novel test apparatus is uncomplicated and inexpensive both to build and operate; yet still capable of fine calibration, repeatability and reproducibility of test conditions. The invention permits a variety of test conditions to emulate the conditions that occur on and off roads. Another significant aspect of the invention is that once the vehicle is fully released, it is free of any carriages or other significant structures that could affect its rollover performance, and nothing significant need be removed from the vehicle before it is tested (other than hazardous materials such as gasoline and oil). It is therefore an object of the invention to enable realistic, controlled, repeatable, and comparable rollover performance testing of actual vehicles, such as production motor vehicles built for both on and off road conditions, under a variety of initial test conditions.

Still another object of the invention is to provide inexpensive rollover test apparatus that requires minimal preparation to conduct tests of actual vehicles.

### INDUSTRIAL APPLICABILITY

This invention can be used by a vehicle manufacturer to develop in rollover resistance and occupant protection of wheeled vehicles that it is manufacturing or planning to manufacture, or to confirm the level of rollover resistance and rollover occupant protection provided by its products. It can also be used by governments, independent organizations, insurance companies, or others for research into the field of vehicle rollover safety and for assessing the rollover safety of vehicles that are used by or are available for sale to the public and to organizations.

I claim:

1. A rotating dynamic rollover test device consisting of a central, vertical axis firmly embedded in the earth to which arms are attached through a hub and bearings such that they can rotate freely in a horizontal plane about the a central axis, with a platform attached firmly to the arms or through hinges at the outboard ends of the arms, that is capable of carrying a wheeled vehicle, and with support wheels under and/or in front of and behind the platform to carry the load placed on the platform over a smooth, circular, level track over which the support wheels ride.

2. The device of claim 1 with power to move the platform in a horizontal circle provided by an engine or motor driving through the support wheels or by other means including directly to the platform or its arms using pneumatic, hydraulic, or electric power applied through belts or cables and pulleys. The power is sufficient to accelerate the platform and a test vehicle to a speed at which an object on the platform is subjected to a centrifugal force (velocity squared divided by radius) in excess of 1.5 times the acceleration of gravity: an amount sufficient to induce a rollover of most wheeled vehicles.

3. The dynamic rollover test device for wheeled vehicles of claims 1 and 2 such that the vehicle being tested is essentially complete as it would be normally used and is not permanently attached to or encumbered by any significant carriages or frames that are not an inherent part of the vehicle.

4. The device of claims 1 and 2 to test a wheeled vehicle for its: dynamic stability and resistance to rolling over, the motion of occupants of the vehicle before and during the first roll, performance of the vehicle's occupant restraint systems before and during a rollover, roof crush resistance when the vehicle's roof strikes the ground during a rollover, and the vehicle's occupant protection capabilities under rollover conditions, and to test any component or system that requires a combination of yaw and longitudinal and lateral acceleration, the vectors of which are orthogonal.

5. A method for conducting tests of wheeled vehicles to measure and assess their stability and rollover propensity; and their occupant motion, occupant restraint performance, occupant compartment integrity, and their occupant protection characteristics under pre-roll and rollover conditions using the device of claims 1, 2, and 4; comprising the steps, for each test, of:
a. installing a test vehicle on the platform, with or without surrogate occupants, and temporarily securing it through quick release devices to the platform;
b. installing instrumentation and video equipment to measure and document the performance factors listed above;
c. applying power to the platform and thus to the vehicle to accelerate them to a speed sufficient to initiate the vehicle's rollover;
d. releasing the vehicle such that it will slide off the platform with its outboard wheels leaving the platform first; falling toward the ground and inducing roll motion as they drop, and striking the ground to further the rollover of the vehicle;
e. documenting the vehicle's dynamic behavior and its occupant's motion and interaction with the occupant restraints prior to and during the vehicle's rollover,
f. measuring and documenting the vehicle's impacts with the ground of impact surface including the deformation of its occupant compartment as the vehicle rolls and travels laterally across that surface; and
g. permitting the vehicle to come to a stop or arresting the vehicle before it undergoes a second roll.

6. The method and purpose of claim 5 for conducting tests of wheeled vehicles except that for a test curbs or other impediments are initially placed on the platform outboard of the test vehicle to induce a rollover on the platform so that the vehicle rolls over onto an impact platform or the ground.

7. For the case where the platform carrying the vehicle is attached by hinges to the control arms, the method and purpose of claims 5 except that once the platform reaches a pre-determined speed, the rollover is initiated by permitting platform and vehicle to roll about the platform's hinges.

8. The method and purpose of claims 5 and 6 for conducting tests of wheeled vehicles except that when a vehicle is installed on the platform, restraining tethers are placed loosely around the vehicle such that when it begins to roll, the tethers prevent it from rolling more than approximately 45° and therefore prevent it from completing the rollover. In this test, a vehicle's pre-roll dynamics, the motion of an occupant at the beginning of a roll, and the performance of the occupant restraints—particularly deployable restraints—are documented and recorded; and the vehicle can be returned to the platform for additional tests. This mode of operation can also be used to check the operation of the system without damaging the test vehicle before conducting a destructive test of the type described in claims 5 and 6.

9. The device of claims 1 and 2 for conducting tests of physical items such as vehicle components such as seats and restraint systems wherein the item is subjected to a high level of acceleration, to a force in an orthogonal direction as it undergoes a yawing motion about an axis that is orthogonal to the acceleration and force vectors.
